(19) United States
(12) Patent Application Publication
(10) Pub. No.: US 2026/0253598 A1
(43) Pub. Date: Aug. 27, 2026

(54) AUTOMATED LOCAL AUDIO REINFORCEMENT AND VOICE LIFT SYSTEMS AND METHODS

(71) Applicant: Shure Acquisition Holdings, Inc., Niles, IL (US)

(72) Inventors: Gregory H. Canfield, Niles, IL (US); Bijal Joshi, Elk Grove Village, IL (US)

(21) Appl. No.: 19/545,575

(22) Filed: Feb. 20, 2026

Related U.S. Application Data
(60) Provisional application No. 63/761,452, filed on Feb. 21, 2025.
(60) Provisional application No. 63/855,281, filed on Jul. 31, 2025.

(51) Int. Cl. G10L 21/0216

(52) U.S. Cl. CPC G10L 21/0216; G10L 2021/02165

(57) ABSTRACT

Various embodiments are directed to a method for adjusting cross point gains of a matrix mixer. For example, the method may receive one or more characteristics associated with an audio system comprising a plurality of microphone arrays each having one or more lobes, a plurality of loudspeakers, and a matrix mixer comprising one or more cross points each configured to connect each of the one or more lobes of the plurality of microphone arrays with each of the plurality of loudspeakers; calculate a potential gain and a desired achievable gain for each of the one or more cross points based on the one or more characteristics and a desired reinforcement level; and apply the desired achievable gain as a gain of the one or more cross points when the potential gain is greater than or equal to the desired achievable gain.

### CROSS-REFERENCE TO RELATED APPLICATIONS

This application claims the benefit of U.S. Provisional Patent Application No. 63/761,452, entitled “AUTOMATED LOCAL AUDIO REINFORCEMENT AND VOICE LIFT SYSTEMS AND METHODS,” which was filed Feb. 21, 2025, and the benefit of U.S. Provisional Patent Application No. 63/855,281, entitled “AUTOMATED LOCAL AUDIO REINFORCEMENT AND VOICE LIFT SYSTEMS AND METHODS,” which was filed Jul. 31, 2025, the entireties of which are hereby incorporated by reference.

### TECHNICAL FIELD

This application generally relates to audio reinforcement in conferencing environments, and more specifically, to systems and methods for automating and optimizing the configuration of audio systems for local audio reinforcement and voice lift.

### BACKGROUND

Conferencing environments, such as conference rooms, boardrooms, video conferencing settings, and the like, can involve the use of microphones (including microphone arrays) for capturing sound from audio sources in the environment (also known as a near end) and loudspeakers for presenting audio from a remote location (also known as a far end). For example, persons in a conference room may be conducting a conference call with persons at a remote location. Typically, speech and sound from the conference room may be captured by microphones and transmitted to the remote location, while speech and sound from the remote location may be received and played on loudspeakers in the conference room. Multiple microphones may be used in order to optimally capture the speech and sound in the conference room.

In some environments, local listeners that are located far away from the talkers (e.g., presenters, teachers, meeting attendees, etc.) in an environment may have difficulty hearing the audio from the talkers. As such, the loudspeakers in the environment may also be used to disseminate and reinforce the audio from the talkers so that all listeners can hear the audio regardless of their location in the environment.

In one scenario that is often referred to as “sound reinforcement,” the sound of a single talker (such as a presenter or teacher) may be reinforced to a general audience area. This may be useful in larger environments used for presentations or classroom settings, for example, so that the sound of the talker may be amplified to be heard by listeners that may be located far away from the talker and/or in noisy situations. The sound of the talker may be played on the loudspeakers in the environment at a slightly higher level so that the talker can be clearly heard while still being comfortable for listeners to hear for long durations.

In another scenario that is often referred to as “voice lift,” the sound of any talker (such as presenters and meeting attendees) that is located anywhere in an environment may be subtly reinforced throughout the environment. The sound of the talkers may be elevated to be heard throughout the environment without it being obvious that the sound has been reinforced, e.g., by providing a minimum amount of gain (e.g., amplification) to the sound of the talkers such that the talkers are intelligible to all of the listeners in the environment. For example, when using a voice lift system, a listener who is farthest from a talker will generally be able to hear the sound of the talker as well as a listener who is close to the talker. In other words, to ensure uniform levels for all talkers in an environment, voice lift may be applied to raise the level of a talker who is far away from a listener, while little or no voice lift may be applied to a talker that is near a listener.

However, it may be difficult, time consuming, and/or require specialized personnel to set up, configure, and adjust an audio system to optimally reinforce sound in both the sound reinforcement and voice lift scenarios. This may include, for example, configuring the cross point routing of a matrix mixer to denote which microphones in an environment should be routed to which loudspeakers, adjusting the individual cross point gains of the matrix mixer to set comfortable levels for listeners, and/or manually adjusting individual cross point gains of the matrix mixer to ensure there is no ringing or feedback. Furthermore, for more complex audio systems with beamforming microphone arrays that automatically deploy lobes, it may be impractical to set the gains in the matrix mixer in an efficient manner due to the number and/or location of lobes that are potentially being added, deleted, and changed in real time.

Using an incorrectly or non-optimally configured audio system can result in feedback and ringing in the environment and for remote listeners at a far end, the sound of talkers not being sufficiently intelligible to listeners in the environment, and/or causing acoustic echo cancellation and/or other digital signal processing systems to perform poorly and/or non-optimally. For example, adding an excessive amount of gain to the level of a talker can cause feedback and ringing, while not adding enough gain to the level of a talker may result in listeners not being able to hear the talker. As another example, an acoustic echo cancellation system may need to constantly readapt and/or be overwhelmed if the sound of a talker from a loudspeaker is too loud and is being continually detected by a microphone array.

Accordingly, there is an opportunity for system and methods that can automatically and optimally set up, configure, adjust, and adapt an audio system to eliminate or reduce the expertise and effort needed to get the audio system to function well in an environment.

### SUMMARY

The techniques of this disclosure are directed to solving the above-noted problems by providing systems and methods that are designed to, among other things: (1) automatically determine potential gains and desired achievable gains of an audio system in order to automatically apply optimal gains as the gains of the cross points of a matrix mixer, microphone arrays, and loudspeakers; (2) automatically apply optimizations to improve the potential gains; (3) automatically determine the gains of the lobes of the microphone arrays to be applied to particular loudspeakers in the environment; and (4) automatically determine the gains of the lobes of the microphone arrays based on zone-based definitions of reinforcement and coverage zones.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram of an exemplary audio system with multiple microphone arrays and loudspeakers, an audio mixer, and a matrix mixer, in accordance with some embodiments.

FIG. 2 is a block diagram of a microphone array configured for automated detection of audio activity that is usable in the audio systems of FIGS. 1 and 8, in accordance with some embodiments.

FIG. 3 is an exemplary top-down depiction of an environment with multiple microphone arrays and loudspeakers, in accordance with some embodiments.

FIG. 4 is a flowchart illustrating operations for adjusting parameters of the audio systems of FIGS. 1 and 8 based on determining potential acoustic gains and desired gains, in accordance with some embodiments.

FIG. 5 is a flowchart illustrating operations for determining the desired achievable gains, in accordance with some embodiments.

FIG. 6 is an exemplary top-down depiction of an environment having zone-based definitions of reinforcement and coverage zones with multiple microphone arrays and loudspeakers, in accordance with some embodiments.

FIG. 7 is a flowchart illustrating operations for automatically determining the gains of lobes of microphone arrays based on the definitions of the reinforcement and coverage zones, in accordance with some embodiments.

FIG. 8 is a block diagram of an exemplary audio system with multiple microphone arrays and loudspeakers, an automixing system, and a matrix mixer, in accordance with some embodiments.

FIG. 9 is a flowchart illustrating operations for automatically modifying cross point gains of a matrix mixer based on the definitions of the reinforcement and coverage zones, in accordance with some embodiments.

### DETAILED DESCRIPTION

The systems and methods described herein can automatically and optimally set up, configure, adjust, and adapt an audio system in an environment based on a variety of factors. Such factors may include the locations of microphone arrays and their lobes; the locations of loudspeakers; the locations of desired audio sources; the acoustic characteristics of the microphone arrays, the loudspeakers, and the environment; and/or the locations and boundaries of reinforcement zones and coverage zones in the environment. The environment may include, for example, relatively large spaces such as conference rooms, classrooms, and the like where talkers and listeners may not necessarily be located close to another. The talkers and listeners may be participating in, for example, a conference call, telecast, webcast, class, seminar, performance, sporting event, etc. These types of environments may benefit from the sound reinforcement of talkers so that listeners located anywhere in the environments are able to clearly and intelligibly hear the talkers.

The audio system can be more optimally and effectively configured using the systems and methods described herein by, for example, automatically determining the potential gains and desired achievable gains of an audio system to enable optimal gains to be applied as the gains of cross points on a matrix mixer that connect the lobes of the microphone arrays to the loudspeakers, automatically applying optimizations to improve the potential gains, and/or automatically determining the gains of the lobes of the microphone arrays to be applied to particular loudspeakers in the environment. In addition, the systems and methods described herein may, as further examples, automatically determine the gains of the lobes of the microphone arrays, or cross points, based on defined reinforcement and coverage zones in the environment.

The full gain path of the audio system may include acoustic gain, processing gain, and device gain. The acoustic gain may include the gain, or attenuation, of the acoustic paths of the audio system in the environment and contribute to the potential acoustic gain and the needed acoustic gain. The processing gain and device gain may include, for example, sensitivities of the microphone arrays, sensitivities of the loudspeakers, input and output gains of devices in the audio system, gains of an automixer, and cross point gains of a matrix mixer. The system and methods herein can calculate and/or estimate the gain of the audio system, including the gain that can be achieved before feedback or ringing occurs (e.g., potential gain, potential acoustic gain), the gain that would give the desired reinforcement level of talkers to listeners (e.g., desired gain, needed acoustic gain), and the gain that can be automatically applied to the audio system (e.g., applied gains, digital signal processor gains, cross point gains of a matrix mixer).

Through use of these systems and methods, the expertise and effort needed to get an audio system to function well in an environment can be reduced or eliminated, such as to maximize the amount of gain that the audio system can produce before feedback and ringing occur. This can result in an improved experience for installers and integrators during setup and configuration of the audio system for the environment, and for talkers and listeners when they are present in the environment during use of the audio system. Environments with more complex audio systems, e.g., those with beamforming microphone arrays that automatically deploy lobes, may particularly benefit due to the ability to adapt to changing conditions quickly and ensure that the sound from talkers is sufficiently intelligible to listeners located throughout the environment.

As used herein, the terms “lobe” and “microphone lobe” may refer to an audio beam generated by a given microphone array (or array microphone) to pick up audio signals at a select location, such as the location towards which the lobe is directed. While the techniques disclosed herein are described with reference to microphone lobes generated by array microphones, the same or similar techniques may be utilized with other forms or types of microphone coverage (e.g., a cardioid pattern, etc.) and/or with microphones that are not array microphones (e.g., a handheld microphone, boundary microphone, lavalier microphones, etc.). Thus, the term “lobe” is intended to cover any type of audio beam or coverage.

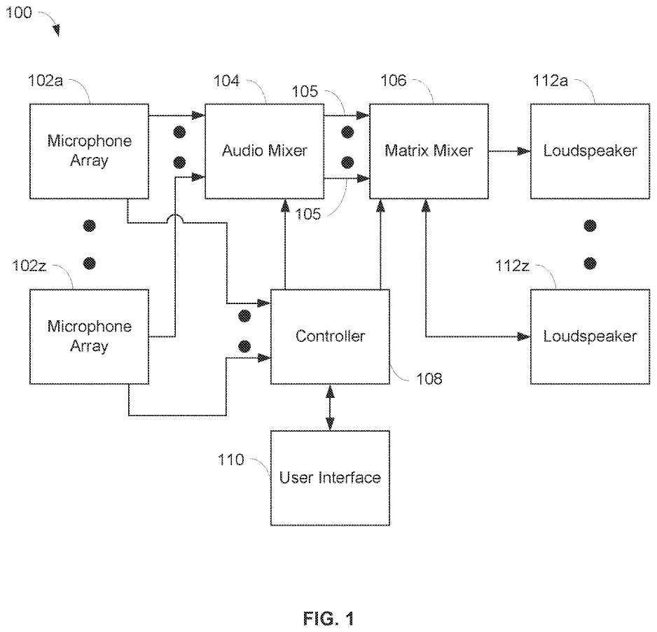

FIG. 1 shows a block diagram of an audio system 100 that includes one or more microphone arrays 102a, . . . , z that can detect the locations of talkers in an environment and sense the sound from audio sources in an environment (e.g., the talkers), an audio mixer 104, a matrix mixer 106, and one or more loudspeakers 112a, . . . , z that can play sound (e.g., from the talkers, from far end audio sources, etc.). The audio system 100 may also include a controller 108 that can receive the location of talkers from the microphone arrays 102a, . . . , z, and a user interface 110 that is communication with the controller 108, as described in more detail below. The controller 108 may also be in communication with the audio mixer 104 and the matrix mixer 106 to control the mixing, routing, and/or other adjustments performed by the audio mixer 104 and the matrix mixer 106.

The microphone arrays 102a, . . . , z may detect and capture sounds from audio sources within an environment. Such sounds may include desired sounds (e.g., human talkers or speakers) and/or undesired sounds (e.g., background noise, spurious noise, non-human noise, non-voice human noise, and/or unwanted human voice). The microphone arrays 102a, . . . , z may be capable of forming one or more pickup patterns with lobes that can be steered to sense audio in particular locations within the environment. In embodiments, the audio signals generated by the microphone arrays 102a, . . . , z may correspond to each of the pickup patterns. The microphone arrays 102a, . . . , z may communicate with the controller 108 via a suitable application programming interface (API), in some embodiments.

The audio signals from the microphone arrays 102a, . . . , z may be received by the audio mixer 104. The audio mixer 104 may generate and output one or more mixed audio signals 105 that may conform to a desired audio mix such that the audio signals from certain microphone arrays are emphasized and the audio signals from other microphone arrays are deemphasized or suppressed.

In some embodiments, the audio mixer 104 may provide an individual output for each microphone lobe signal with gating gain applied (e.g., gated direct outputs) that may be individual inputs to the matrix mixer 106. In other embodiments, the individual outputs of the audio mixer 104 may not have gating gains applied (e.g., non-gated direct outputs), or the signals from microphone lobes may be routed directly to inputs of the matrix mixer 106. Exemplary embodiments of audio mixers are disclosed in commonly-assigned patents, U.S. Pat. Nos. 4,658,425 and 5,297,210, each of which is incorporated by reference in its entirety.

The matrix mixer 106 may be used to flexibly route and/or mix one or more audio signals (e.g., mixed audio signals 105 from the audio mixer 104, audio signals from the microphone arrays 102a, . . . , z, audio from the far end, etc.) to one or more of the loudspeakers l 12a, . . . , z for playing in the local environment and/or to a far end (not shown) for playing at a remote location, such as by connecting the cross points between the audio signals and the loudspeakers 112. For example, audio signals may be routed and/or mixed with other audio signals by the matrix mixer 106 by setting appropriate gain values at particular cross points.

In embodiments, the matrix mixer 106 may generate further mixed audio signals by combining particular mixed audio signals from the audio mixer 104 and/or particular audio signals from the microphone arrays 102a . . . , z. In some embodiments, the matrix mixer 106 may generate a unique mixed audio signal for each loudspeaker 112a, . . . , z, while in other embodiments, the matrix mixer 106 may provide the same mixed audio signal to two or more of the loudspeakers 112a, . . . , z. For example, the matrix mixer 106 may be used to route the sound detected by a microphone array 102 from a presenter located at one end of a room to be played on a loudspeaker 112 that is located at an opposite end of the room.

The matrix mixer 106 may also be able to apply and adjust the cross point gains between particular input audio signals and a particular loudspeaker 112. Adjusting the cross point gains may effectively create separate submixes, e.g., for each loudspeaker 112, by controlling how much of particular input audio signals are routed and mixed by the matrix mixer 106 to be output to a particular loudspeaker 112. In other words, certain input audio signals to the matrix mixer 106 may be either included or removed from the output of the matrix mixer 106. In one example, the audio system 100 may include the audio signals 105 from 32 lobes (from four microphone arrays 102 with eight lobes each) that can be connected to eight loudspeakers 112 using the matrix mixer 106. In this example, there may be 256 cross points in the matrix mixer 106 to enable each lobe to be potentially connected to each loudspeaker 112.

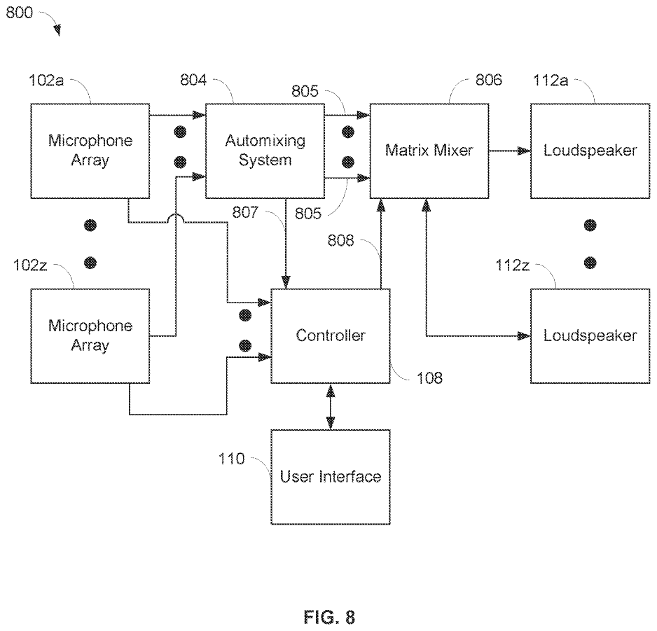

FIG. 8 shows a block diagram of an audio system 800 that is similar to the audio system 100 of FIG. 1, but includes an automixing system 804 that may generate and output one or more submix audio signals 805 based on audio signals from the microphone arrays 102a, . . . , z. In addition, the automixing system 804 may generate a gating control signal 807 that indicates which of the individual channels are gated on in the submix audio signals 805. The controller 108 may receive the gating control signal 807 from the automixing system 804 and use the gating control signal 807, along with other information, to generate a control signal 808 that is transmitted to the matrix mixer 806. The matrix mixer 806 may apply gains optimally when submix audio signals 805 are received, based on the control signal 808 received from the controller 108.

The matrix mixer 806 may be similar to the matrix mixer 106 described above but may also receive the submix audio signals 805 and the control signal 808. The matrix mixer 806 may be able to apply and adjust the cross point gains between particular submix audio signals and a particular loudspeaker 112, based on the control signal 808 received from the controller 108. In particular, the control signal 808 may denote which of the submix audio signals contain channels that have been gated on, and the cross point gains of the matrix mixer 806 may be adjusted based on which individual channels are gated on in the submix audio signals 805. In embodiments, the gains for the underlying cross points (e.g., the cross points associated with the lobes that make up the submix audio signal) may be applied and adjusted for the cross-points of the gated-on submix audio signal.

Exemplary embodiments of an automixing system 804 are disclosed in a commonly-assigned patent, U.S. Pat. No. 8,644,477, and a commonly-assigned patent application, U.S. Pat. App. Pub. No. 2023/0104602, both of which are incorporated by reference in their entirety. In an example, the audio system 800 may include four submix audio signals 805 (one submix audio signal 805 from each microphone array 102) that can be connected to eight loudspeakers 112 using the matrix mixer 806. In this example, there may be 32 cross points in the matrix mixer 806 to enable each submix audio signal 805 to be potentially connected to each loudspeaker 112. Through the use of such an automixing system 804, the number of signals routed to the matrix mixer 806 may be reduced, as compared to the matrix mixer 106 of the audio system 100.

In an embodiment, the automixing system 804 may have functionality that is executed on the microphone array 102 and on an aggregator device (not shown). In this embodiment, the microphone array 102 may calculate reduced bandwidth metrics and a submix audio signal, which may be transmitted to the aggregator device. The aggregator device may calculate a global gating decision (e.g., gating control signal 807) and transmit the global gating decision to the microphone array 102. In embodiments, the microphone array 102 may utilize the transport mechanism that is used to transmit the reduced bandwidth metrics to the aggregator unit to also transmit the locations of lobes and/or other information that can be used by an automatic voice lift algorithm.

In embodiments, the audio system 800 may calculate the optimal gains for the matrix mixer 806 for 256 cross points (e.g., when there are 32 lobe audio signals to eight loudspeaker outputs), even though the matrix mixer 806 may only include 32 cross points (e.g., representing four array submix audio signals to eight loudspeaker outputs). Accordingly, when the gating control signal 807 indicates to the controller 108 that a particular lobe from the microphone array 102 is gated on in a submix audio signal 805, the controller 108 may utilize the eight cross point gains from the optimal set of 256 cross points for that particular lobe to the eight loudspeakers 112, and apply those eight cross point gains to the cross points of the matrix mixer 806 (e.g., that are for that particular submix audio signal 805 that is going to the eight loudspeakers 112). In this fashion, when only one lobe of a microphone array 102 is gated on in a particular submix audio signal 805, the controller 108 can update the cross points of the matrix mixer 806 based on the gating state, and the same distribution of a lobe of the microphone array 102 to the loudspeakers 112 can be achieved with a matrix mixer 806 having 32 cross points that is operating on submixes, as would be achieved with a matrix mixer 806 having 256 cross points that operates with every lobe of the microphone arrays 102 as inputs.

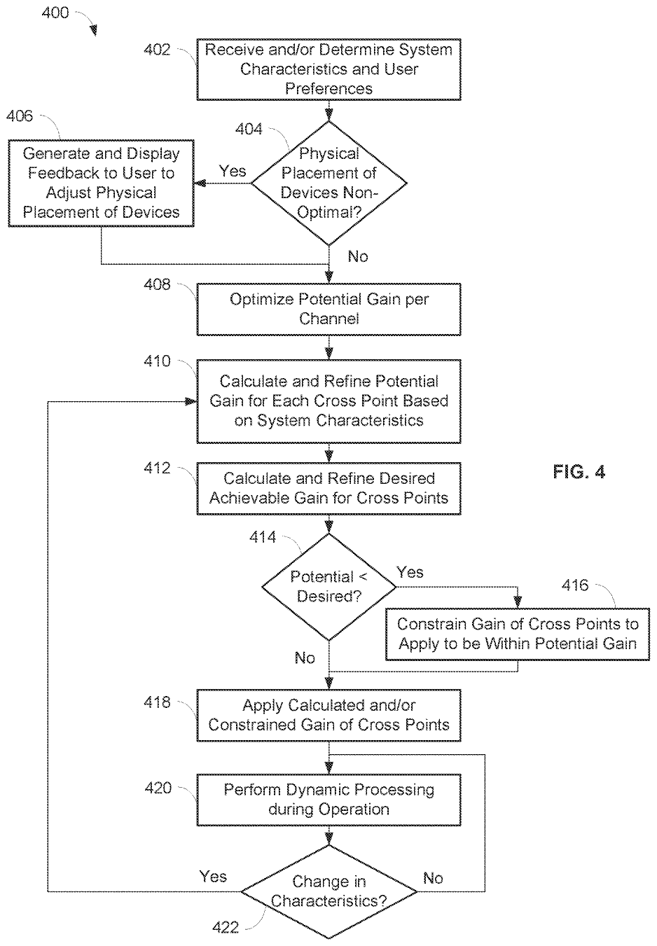

Some or all of the components of the audio system 100, 800 may be implemented using software executable by one or more computers, such as a computing device having a processor and memory (e.g., a personal computer (PC), a laptop, a tablet, a mobile device, a smart device, thin client, etc.), and/or by hardware (e.g., discrete logic circuits, application specific integrated circuits (ASIC), programmable gate arrays (PGA), field programmable gate arrays (FPGA), digital signal processors (DSP), microprocessor, etc.). For example, some or all components of the audio system 100, 800 may be implemented using discrete circuitry devices and/or using one or more processors (e.g., audio processor and/or digital signal processor) executing program code stored in a memory (not shown), the program code being configured to carry out one or more processes or operations described herein, such as, for example, the methods shown in FIGS. 4, 5, and 7. Thus, in embodiments, the audio system 100, 800 may include one or more processors, memory devices, computing devices, and/or other hardware components not shown in FIGS. 1 and 8. It should be understood that the components shown in FIGS. 1 and 8 are merely exemplary, and that any number, type, and placement of the various components of the audio system 100, 800 are contemplated and possible. In some embodiments, the components of the audio system 100, 800 may be physically located in and/or dedicated to a particular environment. In other embodiments, the components of the audio system 100, 800 may be part of a network and/or distributed in a cloud-based environment.

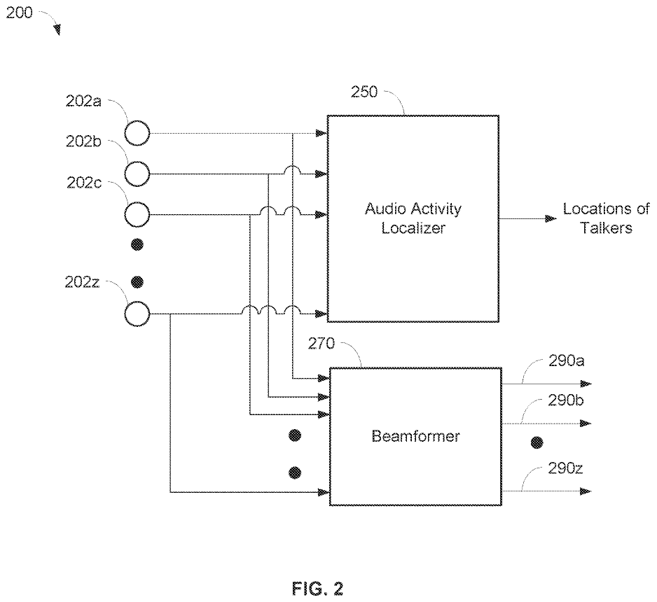

FIG. 2 shows a block diagram of a microphone array 200, such as any of the microphone arrays 102a, . . . , z of FIG. 1, that is usable in the audio system 100 of FIG. 1 and in the audio system 800 of FIG. 8 for detecting sounds from audio sources in an environment. The microphone array 200 may include any number of microphone elements 202a, b, c, . . . , z, for example, and be able to form one or more pickup patterns with lobes so that the sound from the audio sources can be detected and captured. Each of the microphone elements 202a, b, c, . . . , z in the microphone array 200 may detect sound and convert the sound to an analog audio signal. The microphone array 200 may also include an audio activity localizer 250 in wired or wireless communication with the microphone elements 202a, b, c, . . . , z, and a beamformer 270 in wired or wireless communication with the microphone elements 202a, b, c, . . . , z.

The microphone elements 202a, b, c, . . . , z may each be a MEMS (micro-electrical mechanical system) microphone with an omnidirectional pickup pattern, in some embodiments. In other embodiments, the microphone elements 202a, b, c, . . . , z may have other pickup patterns and/or may be electret condenser microphones, dynamic microphones, ribbon microphones, piezoelectric microphones, and/or other types of microphones. In embodiments, the microphone elements 202a, b, c, . . . , z may be arrayed in one dimension or multiple dimensions.

Other components in the microphone array 200, such as analog to digital converters, processors, and/or other components (not shown), may process the analog audio signals and ultimately generate one or more digital audio output signals. The digital audio output signals may conform to suitable standards and/or transmission protocols for transmitting audio. In embodiments, each of the microphone elements in the microphone array 200 may detect sound and convert the sound to a digital audio signal.

One or more digital audio output signals 290a, b, . . . , z may be generated corresponding to each of the pickup patterns. The pickup patterns may be composed of one or more lobes, e.g., main, side, and back lobes, and/or one or more nulls. The pickup patterns that can be formed by the microphone array 200 may be dependent on the type of beamformer used with the microphone elements, such as beamformer 270. For example, a delay and sum beamformer may form a frequency-dependent pickup pattern based on its filter structure and the layout geometry of the microphone elements. As another example, a differential beamformer may form a cardioid, subcardioid, supercardioid, hypercardioid, or bidirectional pickup pattern.

The audio activity localizer 250 may determine the location of audio activity in an environment based on the audio signals from the microphone elements 202a, b, c, . . . , z. In embodiments, the audio activity localizer 250 may utilize a Steered-Response Power Phase Transform (SRP-PHAT) algorithm, a Generalized Cross Correlation Phase Transform (GCC-PHAT) algorithm, a time of arrival (TOA)-based algorithm, a time difference of arrival (TDOA)-based algorithm, or another suitable sound source localization algorithm. The audio activity that is detected may include desired audio sources, such as human talkers, and/or undesired audio sources, such as noise from computer equipment, etc. The location of the audio activity may be indicated by a set of three-dimensional coordinates relative to the location of the microphone array 200, such as in Cartesian coordinates (i.e., x, y, z), or in spherical coordinates (i.e., radial distance/magnitude r, elevation angle 8 (theta), azimuthal angle cp (phi)). It should be noted that Cartesian coordinates may be readily converted to spherical coordinates, and vice versa, as needed. In embodiments, the audio activity localizer 250 may be included in the microphone array 200, may be included in another component, or may be a standalone component.

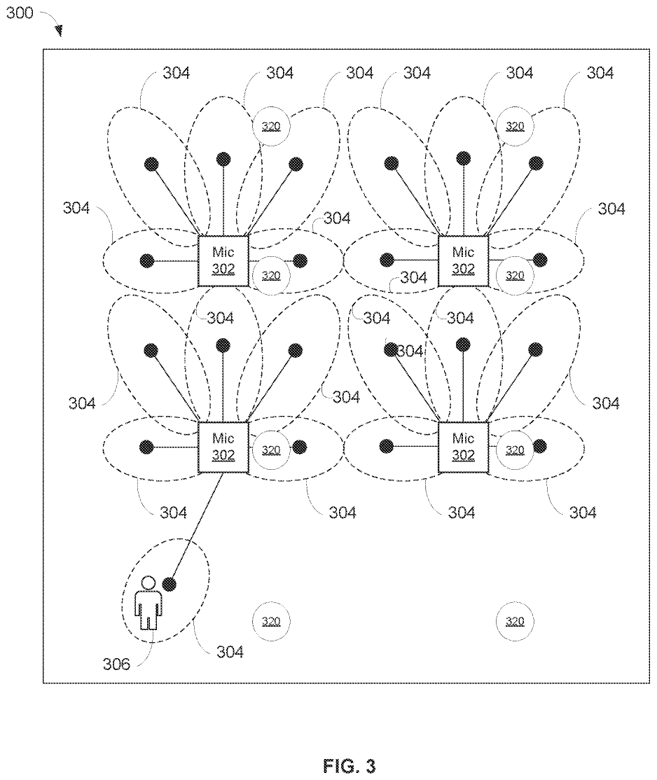

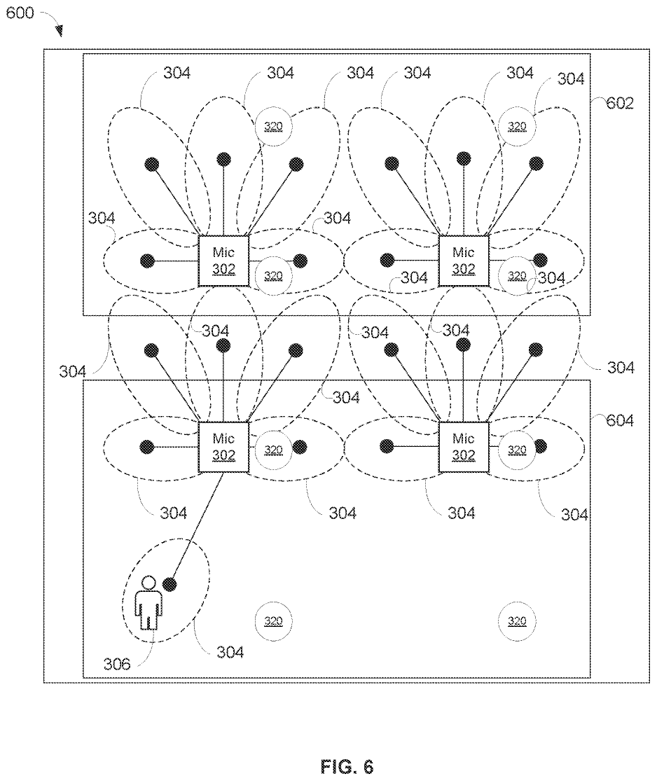

FIGS. 3 and 6 are exemplary top-down depictions of environments 300, 600 in which the systems and methods disclosed herein may be used. In particular, FIGS. 3 and 6 show respective environments 300, 600 that include multiple microphone arrays 302 (e.g., microphone array 200) and multiple loudspeakers 320. The environments 300, 600 may be, for example, relatively large spaces such as a conference room or classroom where one or more talkers and one or more listeners may be located in various locations that could be relatively near or relatively far from one another. The environments 300, 600 may also include objects such as tables, chairs, podiums, cameras, etc. that are not shown in FIGS. 3 and 6.

Each of FIGS. 3 and 6 depict the locations of the microphone arrays 302 by solid squares, the lobes 304 of the microphone arrays 302 using dotted lines, and the locations of the loudspeakers 320 by solid circles. It should be appreciated that while the microphone arrays 302, their lobes 304, and the loudspeakers 320 are shown in particular quantities and locations in the environments 300, 600 depicted in FIGS. 3 and 6, other quantities and locations are possible and contemplated. It should further be appreciated that the systems and methods described herein can be utilized for environments other than the exemplary environments 300, 600 that are depicted in FIGS. 3 and 6.

As a non-limiting example, in the environments 300, 600 of FIGS. 3 and 6, the microphone arrays 302 and loudspeakers 320 may be physically located on the ceiling of the room, but may be located elsewhere (e.g., walls of the room). The walls of the environments 300, 600 are denoted by the solid lines around the perimeters of FIGS. 3 and 6. The use of multiple microphone arrays 302 may improve the sensing and capture of sounds from audio sources in the environments 300, 600. For example, certain microphone arrays 302 may be utilized to sense particular talkers that are located nearer to those microphone arrays 302.

As can be seen in FIGS. 3 and 6, the microphone arrays 302 may be positioned throughout the environments 300, 600 such that their lobes 304 can be configured to optimally detect sounds (e.g., talkers) in the environments 300, 600. For example, the lobes 304 of the microphone arrays 302 in FIGS. 3 and 6 may be steered to cover the area where an audience may typically be located and/or where a presenter 306 may typically be located. In this way, sounds from a talker (e.g., an audience member or the presenter 306) can be sensed by the microphone arrays 302.

In a sound reinforcement scenario, the sound from the presenter 306 may be reinforced over the loudspeakers 320 to the audience area so that listeners in the audience are able to clearly hear the presenter 306. In particular, a particular lobe 304 from the bottom left microphone array 302 may be steered to cover the location of the presenter 306, as shown in FIGS. 3 and 6. The presenter 306 may be at or around that location because there is a lectern or podium located there, for example. The sound from the presenter 306 may be detected by the lobe 304 and amplified to be played on the loudspeakers 320 to the audience area. The other lobes 304 of the microphone arrays 302 may be gated off in the sound reinforcement scenario, in some embodiments, so that sounds from elsewhere in the environment 300, 600 are not detected, e.g., sounds from the audience area.

In a voice lift scenario, the sound from any talker may be reinforced over the loudspeakers 320 throughout the environment 300, 600. In particular, any of the lobes 304 from any of the microphone arrays 302 may detect the sound from a talker in the environment 300, 600. The sound from a talker may be detected by a lobe 304 of a microphone array 302 and selectively amplified to the listeners in the environment 300, 600 using one or more of the loudspeakers 320, based on the locations of the talker and the locations of the listeners. For example, when a particular lobe 304 from a microphone array 302 detects sound from a talker in a certain location, the gain of that lobe 304 may be adjusted to raise the level of the talker's sound by a certain amount to be played on the loudspeakers 320 that are located farthest away from the talker. Conversely, the gain of that lobe 304 may be adjusted to raise the level of the talker's sound by a lesser amount to be played on the loudspeakers 320 that are located nearer the talker. In some cases, the talker's sound may not be played on such nearer loudspeakers 320 at all, such as when the listeners located close to those nearer loudspeakers 320 would be able to intelligibly hear the talker directly. In this way, listeners that are located far away from a talker are able to intelligibly hear the talker's sound as well as listeners that are located near the talker.

FIG. 6 also includes exemplary definitions of areas for a reinforcement zone 602 and for a coverage zone 604, as depicted by the solid lines in the interior of the environment 600. The boundaries of the reinforcement zone 602 and the coverage zone 604 may be defined by a user, for example. The reinforcement zone 602 may define an area in the environment 600 where the sound from talkers and other desirable sources may be reinforced to over certain loudspeakers 320, such as by increasing the volume of the sounds played on the loudspeakers 320 in that area. The coverage zone 604 may define an area in the environment 600 where the sound from talkers and other audio sources may be sensed by the microphone arrays 302 and reinforced within the environment 600.

Turning to FIG. 4, a process 400 may automatically adjust parameters of the audio system 100, 800, based on determining potential gains and desired achievable gains. In particular, the potential gains and the desired achievable gains may be calculated for each of the potential paths from the elements of the microphone array 302 (or from lobes 304) to each of the loudspeakers 320, based on characteristics associated with the audio system 100, 800 in the environment. The potential gain for a particular path may be the maximum amount of gain that can be set for a particular path (e.g., from a lobe 304 of a microphone array 302 to a loudspeaker 320) before feedback and ringing occurs, e.g., when sounds are played on the loudspeakers 320. For example, the potential gain for a particular path may include the potential acoustic gain, device gains, and processing gains that can be set before feedback and ringing occurs.

The desired achievable gain for a particular path may be the amount of gain that would ideally be needed so listeners covered by that reinforcement path can optimally hear the sound of a talker on the loudspeakers 320. For example, determining the desired achievable gain for a particular path may take into account the needed acoustic gain, device gains, processing gains, and any user-specified desired gain (e.g., when a user desires more reinforcement). Feedback and ringing may occur, for example, when the level of the desired achievable gain subtracted from the level of the potential gain is negative, and conversely, feedback and ringing may not occur when the level of the desired achievable gain subtracted from the level of the potential gain is zero or positive.

The process 400 may result in comparing the calculated potential gains and the calculated desired achievable gains to constrain the calculated level for each of the paths from the elements of the microphone array 302 (or lobes 304) to each of the loudspeakers 320. In some embodiments, there may be a cross point gain in the matrix mixer 106 for each of the calculated paths. In this case, a direct calculation may be performed for each of the cross point gains of the matrix mixer 106 based on the calculated levels for each of the paths.

In other embodiments, there may not be a direct mapping from the paths to the cross points of the matrix mixer 106. This includes, for example, when the matrix mixer 106 receives an input that is a submix of multiple pickup patterns, or when the output of the matrix mixer 106 is routed to multiple loudspeakers 320. In this case, more detailed techniques may be used to determine the values for the cross point gains that may apply to multiple lobes or loudspeakers, since the cross point gains would not represent the path from one lobe to one loudspeaker. For example, in the audio system 800 of FIG. 8, the matrix mixer 806 may receive a gated submix audio signal 805 from each of the microphone arrays 102 and the controller 108 may set the gains of the matrix mixer 806 based on the levels calculated for the full set of paths and also based on which individual lobes or pickup patterns of the microphone arrays 102 are gated on. In embodiments, the cross point gains may be adjusted using the process 400 based on the desired achievable gains and the potential gains, in order to optimize the gain settings and achieve the desired reinforcement levels in the environment, e.g., so that the listeners in the environment can intelligibly hear the sound from talkers.

At step 402 of the process 400, the controller 108 may receive and/or determine characteristics associated with the audio system 100, 800. Such characteristics may include, for example, the locations of the microphone arrays 302 and their lobes 304, the locations of the loudspeakers 320, the locations of desired audio sources in the environment (e.g., talkers), the locations of listeners, levels of acoustic coupling between the microphone array 302 and the loudspeakers 320, and/or user-specified preferences for behaviors of the audio system 100, 800, e.g., particular desired gains, zone definitions, whether voice lift or sound reinforcement is desired, microphone sensitivity, loudspeaker sensitivity, lobe characteristics,, etc. In some embodiments, the relative locations between the microphone arrays 302, loudspeakers 320, and/or desired audio sources may be determined, while in other embodiments, the absolute locations of the microphone arrays 302, loudspeakers 320, and/or desired audio sources may be determined.

Some or all of the characteristics associated with the audio system 100, 800 may have been manually entered, in some embodiments, such as through the user interface 110. In other embodiments, some or all of the characteristics associated with the audio system 100, 800 may be automatically determined. For example, as described above, an audio activity localizer 250 in a microphone array 200 may execute an audio localization algorithm to determine the location of a talker and/or loudspeakers 320 by sensing audio activity from the talker and/or loudspeakers.

As another example, the acoustic coupling between the microphone arrays 302 and the loudspeakers 320 may be determined by an acoustic echo cancellation algorithm, for example, by playing particular calibration signals on the loudspeakers 320 to be sensed by the microphone arrays 302, or based on information known about the components of the audio system 100, 800 (e.g., their locations and settings). Measuring the acoustic coupling may take into account, for example, the influence of the position of the walls in the environment, surface coatings, and/or other characteristics. These characteristics may not necessarily be considered in the basic calculation of the potential gain, which estimates the portion of the potential feedback path between a microphone and a loudspeaker using factors such as distance, direction and type of microphone lobe and expected device characteristics.

At step 404, the controller 108 may determine whether the physical placement of the microphone arrays 302 and loudspeakers 320 in the environment may be expected to result in poor or non-optimal performance of the audio system 100, 800. Poor or non-optimal performance of the audio system 100, 800 may include a greater tendency for feedback or ringing on the loudspeakers 320. For example, if a microphone array 302 is located too close to a loudspeaker 320, the sound from the loudspeaker 320 may dominate what is sensed by the microphone array 302, which can adversely affect how gains are calculated in the audio system 100, 800. As other examples, the number and/or placement of the loudspeakers 320 or the number and/or placement of the microphone arrays 302 may not provide optimal coverage when a voice lift scenario is being implemented in the environment.

If the physical placement of the microphone arrays 302 and loudspeakers 320 is considered non-optimal (“YES” branch) at step 404, then the process 400 may continue to step 406. At step 406, feedback may be generated and displayed by the controller 108, e.g., on the user interface 110, to inform users (such as installers and integrators) of the non-optimal physical placement of the microphone arrays 302 and loudspeakers 320. The feedback generated and displayed at step 406 may include suggestions on how to adjust and optimize the physical placement of the microphone arrays 302 and loudspeakers 320 to achieve better performance of the audio system 100, 800. The system characteristics from step 402 may be updated following any adjustments and optimizations performed by a user in response to the feedback at step 406. The process 400 may continue to step 408 following step 406. The process 400 may also continue to step 408 if, at step 404, the physical placement of the microphone arrays 302 and loudspeakers 320 is not considered non-optimal (“NO” branch) (e.g., is considered optimal or will result in sufficient performance of the audio system 100, 800).

At step 408, the potential gains of input channels and/or output channels of the audio system 100, 800 may be optimized by the controller 108, in order to improve the gain before feedback for the sound being reinforced in the environment. In some embodiments, the potential gains may be optimized based on the frequency response characteristics of the audio system 100, 800 by applying frequency dependent filtering. In embodiments, the controller 108 may identify that a loudspeaker 320 or microphone array 302 has peaks in their frequency response and apply parametric cut filters to level the response in order to improve the potential gains. In some embodiments, the peaks in the frequency responses may be determined based on the general characteristics of the components of the audio system 100, 800, while in other embodiments, automatic measurement techniques could be performed, e.g., during a setup phase of the audio system 100, 800. In embodiments, the controller 108 can utilize knowledge of the frequency dependent characteristics of the microphone lobes to optimize the potential gains by applying a low frequency shelf filter to attenuate the level at lower frequencies where there may be a lower potential acoustic gain due to the lack of lobe directivity at low frequencies, giving the audio system 100, 800 a higher overall potential acoustic gain.

In other embodiments, the potential gains may be optimized at step 408 by filtering the sound of the desired audio source using dynamic feedback reduction. Dynamic feedback reduction may include attenuating frequencies of the sound of the desired audio source that exceed a particular threshold. An initial setup phase of dynamic feedback reduction may include applying notch filters based on the characteristics of the environment.

Following step 408, at step 410, the potential gains for the cross points of the matrix mixer 106, 806 may be calculated by the controller 108 based on the characteristics of the audio system 100, 800 from step 402. For example, the potential gain for a certain cross point path may be calculated based on when the reinforced acoustic gain on the path between a given microphone array 302 and loudspeaker 320 is greater than the acoustic attenuation of the sound traveling from the loudspeaker 320 back to the microphone array 302. If the overall gain on that feedback loop is greater than unity, the level of amplified sound will continue to increase and acoustic feedback may be heard. Both the acoustic attenuation factor and the reinforced gain may also be calculated. The acoustic attenuation between the loudspeaker 320 and the microphone array 302 may be determined based on the distance between the loudspeaker 320 and the microphone array 302 (from step 402) and based on acoustic principles. The gain in the reinforcement path may include the directionality and orientation of the pickup pattern of the microphone array 302, the sensitivity of the microphone array 302, the gain applied by the controller 108, the sensitivity of the loudspeaker 320, and/or the amplification level of the loudspeaker 320. The potential gain may include the gain applied by the controller 108 that would cause the feedback loop gain to be positive and have acoustic feedback occur. In some embodiments, the potential gains for all of the cross points may be calculated at step 410. In other embodiments, the potential gains for certain cross points may be calculated at step 410.

The initially calculated potential gains for one or more of the cross points may be refined at step 410. For example, the calculated potential gain for a particular cross point may be refined by being decreased as lobes from a particular microphone array 302 are routed to multiple loudspeakers 320 (e.g., number of open loudspeaker attenuation). As another example, there may be certain situations where the calculated potential gain for a particular cross point may be refined by being zeroed out (e.g., muted), such as when a lobe of a particular microphone array 302 is known to be located too close to a loudspeaker 320. As a further example, a factor may be applied if the calculated potential gain does not exactly match up with the onset of ringing or feedback.

Following step 410, at step 412, the desired achievable gains for one or more of the cross points of the matrix mixer 106, 806 may be calculated by the controller 108 based on the characteristics of the audio system 100, 800 from step 402. The desired achievable gain for a particular cross point may be calculated based on determining a volume of a desired audio source as compared to a desired volume of the desired audio source, and then calculating the desired achievable gain such that the volume of sound of the desired audio source is played on a loudspeaker 320 to be at a sufficient sound pressure level in the environment. In some embodiments, the desired achievable gain may be calculated for certain cross points at step 412, such as the cross points associated with the lobes 304 that are currently sensing the sound from a desired audio source. In other embodiments, the desired achievable gain may be calculated for all cross points at step 412.

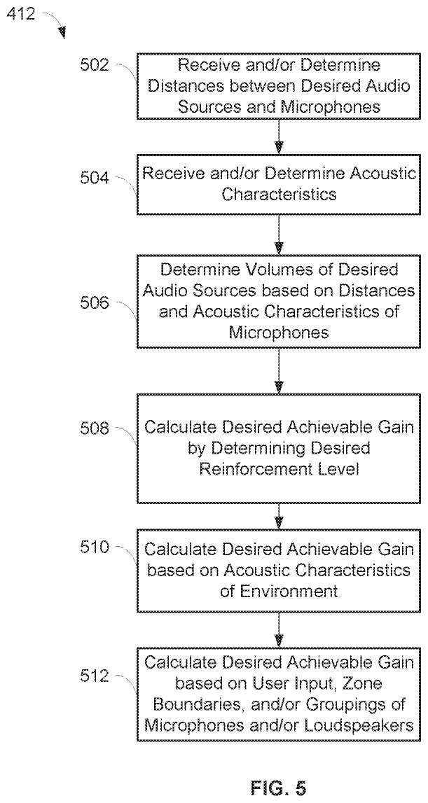

An embodiment of step 412 for calculating the desired achievable gain of the cross points of the matrix mixer 106, 806 is described in more detail below in FIG. 5. In addition, the initially calculated desired achievable gains for one or more of the cross points may be refined at step 412. For example, the calculated desired achievable gain for a particular cross point may be refined by being decreased in situations where multiple loudspeakers are playing the same sound (e.g., number of open loudspeaker attenuation). As another example, there may be certain situations where the calculated desired achievable gain for a particular cross point may be refined by being set to zero (e.g., to have no reinforcement), such as when a listener is located relatively close to a talker and can already intelligibly hear sound from the talker.

Following step 412, at step 414, the potential gain for a cross point (calculated and/or refined at step 410) may be compared to the desired achievable gain for the cross point (calculated and/or refined at step 412) by the controller 108 to determine whether the potential gain is less than the desired achievable gain. If the potential gain is not less than the desired achievable gain at step 414 (“NO” branch) (i.e., is greater than or equal), then the process 400 may continue to step 418. At step 418, the desired achievable gain from step 412 may be applied as the gain of the cross point by the controller 108. In this scenario, the desired achievable gain calculated at step 412 may be applied as the gain of the cross point since the controller 108 has determined that there is enough potential gain available in the audio system 100, 800. By adjusting the gain of the cross point to the desired achievable gain, the resulting playing of the sound of a desired audio source on a loudspeaker 320 may be optimized to achieve the desired reinforcement level, e.g., to be intelligible to listeners.

However, if the potential gain is less than the desired achievable gain at step 414 (“YES” branch), then the process 400 may continue to step 416. At step 416, the gain of the cross point may be constrained by the controller 108 to be within the potential gain calculated at step 408. For example, the gain of the cross point may be constrained to be a maximum of the level of the potential gain from step 408. In this scenario, even though the gain of the cross point cannot be adjusted to the level of the desired achievable gain, adjusting the gain of the cross point to the maximum possible level (e.g., the level of the potential gain) may still enable listeners to better hear the sound of a desired audio source being played on a loudspeaker 320, as compared to if the gain of the cross point was not adjusted at all. Following step 416, the process 400 may continue to step 418 to apply the constrained gain as the gain of the cross point.

As an example, a lobe 304 covering a talker 306 may be used to reinforce the sound through a loudspeaker 320 in the middle of the room and also a loudspeaker 320 in the far comer. The desired achievable gain for the cross point of the matrix mixer 106, 806 from the lobe 304 to the loudspeaker 320 in the middle of the room may be at −10 dB, while the desired achievable gain to the loudspeaker 320 in the far comer of the room could be +3 dB since greater gain would be needed at that location due to increased distance from the talker 306. If the potential gain for the lobe 304 to the loudspeaker 320 in the middle of the room is at −9 dB, the cross point may be set to the desired achievable gain of −10 dB. If the potential gain for the cross point for the lobe 304 to the loudspeaker 320 in the far comer of the room is +1 dB, the gain of that cross point would be limited to +1 dB since the gain could not be set to the +3 dB desired achievable gain.

Following step 418, the process 400 may continue to step 420. At step 420, dynamic signal processing may be performed on an input channel and/or an output channel of the audio system 100, 800, in order to reduce and mitigate feedback and/or ringing during operation of the audio system 100, 800 (e.g., when the audio system 100, 800 is actively being used in a teleconference). For example, the dynamic signal processing performed at step 420 may include executing a digital feedback reduction function, using a limiter or compressor, or executing a number of open microphones attenuator function (e.g., to attenuate the gating gain when multiple microphones are gated on).

Following step 420, the process 400 may continue to step 422. At step 422, it can be determined whether there has been a change in the characteristics associated with the audio system 100, 800. The change in a characteristic may be detected automatically, in some embodiments, or be input manually by a user, in other embodiments. For example, the audio activity localizer 250 may detect that a talker's location has changed in the environment, and/or a lobe 304 of a microphone array 302 may change (e.g., be deployed or moved) in response to the new location of the talker. As another example, a location or parameter of a device in the audio system 100, 800 may change. This could occur if a user enters the change in the location or parameter through the user interface 110.

If it is determined that there has been a change in the characteristics associated with the audio system 100, 800 at step 422 (“YES” branch), then the process 400 may return to step 410 to recalculate the potential gains for the cross points of the matrix mixer 106, 806 and to step 412 to recalculate the desired achievable gains for the cross points. In some embodiments, only the potential gains and desired achievable gains for the cross points that are pertinent to the change in characteristics may be recalculated at steps 410 and 412. For example, if a lobe 304 of a microphone array 302 has moved, then the potential gains and desired achievable gains for the cross points associated with that particular lobe 304 may be recalculated at steps 410 and 412.

However, if it is determined that there has not been a change in the characteristics associated with the audio system 100, 800 at step 422 (“NO” branch), then the previously applied calculated and/or constrained gains of the cross points may be maintained (as had been performed at step 418), and the process 400 may return to step 420 to perform dynamic processing during operation of the audio system 100, 800, as described previously.

FIG. 5 shows an embodiment of a process 412 that may correspond to step 412 of the process 400 of FIG. 4. The process 412 shown in FIG. 5 may result in the calculation of desired achievable gains for one or more of the cross points of the matrix mixer 106, 806, and which may be used later in the process 400 of FIG. 4. As examples, the calculated desired achievable gains may be refined in certain situations, such as when multiple loudspeakers are playing the same sound or when a listener is located relatively close to a talker and can already intelligibly hear sound from the talker.

At step 502, distances between locations of desired audio sources (e.g., talkers) and the microphone arrays 302 may be received at and/or determined by the controller 108. The distances at step 502 may be manually entered, in some embodiments (e.g., through the user interface 110), or may be automatically determined, in other embodiments. For example, as described above, an audio activity localizer 250 in a microphone array 200 may execute an audio localization algorithm to determine the location of a talker relative to the microphone array 200 by sensing audio activity, e.g., speech, from the talker. The distance between a desired audio source and a microphone array 302 may impact the desired achievable gain if, for example, the desired audio source is located farther away from the microphone array 302 such that the sound from the desired audio source is not optimally sensed by the microphone array 302. In embodiments, the locations of the microphone arrays 302 and/or loudspeakers 320 may be determined at step 502 via user input and/or localization methods, for example.

At step 504, the controller 108 may receive and/or determine acoustic characteristics associated with the microphone arrays 302, the loudspeakers 320, and/or the environment. Such acoustic characteristics may include, for example, the types of microphone arrays 302 and loudspeakers 320, the directionality, shapes, and/or pickup patterns of the lobes 304 of the microphone arrays 302, and/or metrics related to the environment (e.g., reverberation time, background noise, etc.) that could be caused by the dimensions, surface materials, etc. of the environment. The acoustic characteristics can affect how sound from a talker can be heard by listeners within an environment when the sound from the talker is played on a loudspeaker 320.

In embodiments, the acoustic characteristics may be manually entered (e.g., through the user interface 110), or may be automatically determined, in other embodiments. For example, the acoustic characteristics of the microphone arrays 302 and/or the loudspeakers 320 may be automatically communicated to the controller 108, such as model, type, pickup patterns, radiation patterns, etc. As another example, the acoustic characteristics of the environment may be automatically determined by the controller 108 by analyzing calibration audio signals that are played on the loudspeakers 320 and sensed by the microphone arrays 302.

Following step 504, the process 412 may continue to step 506 and step 508 where the locations from step 502 and the characteristics from step 504 may be used in calculating the desired achievable gain for the path between a lobe 304 and a loudspeaker 320 to ensure that the volume of the sounds of the desired audio sources are played on the loudspeakers 320 to be at a sufficient sound pressure level such that listeners can intelligibly hear the sounds of the desired audio sources.

For a given lobe 304 and a given loudspeaker 320, the level of acoustical reinforcement may be determined that is needed for a talker in the coverage area of the lobe 304 to be reinforced to a listener in the coverage area of the loudspeaker 320. The level of acoustical reinforcement can be determined using the talker's position (whether estimated or measured) and using an assumed position of a listener that is based on the position of the loudspeaker 320. For example, the desired acoustic reinforcement level may be calculated to be the level which has the volume of the talker in the coverage area of the loudspeaker 320 approximately equal to the level at an ideal unamplified listening position, e.g., where the talker can be heard throughout the room at the level the talker would be heard at a distance of six feet.

The amount of acoustical falloff from the ideal listening distance to the position of the listener may be calculated based on the ideal listening distance, the distance between the talker and the listener, and acoustic propagation rules. The level of acoustical reinforcement that is needed in this scenario may be the level which, when added to the distance-attenuated direct sound from the talker, would bring the total level at the position of the listener to the level that would be heard at the ideal listening distance. If the position of the listener is near the ideal listening distance, little or no acoustical reinforcement would be needed, or if the position of the listener is closer than the ideal listening distance, no acoustical reinforcement would be needed. However, if the position of the listener is far away from the talker, then the direct sound from the talker would be highly attenuated, and the added acoustic level from the reinforcement path would need to be nearly the volume of the talker's voice at the ideal listening distance.

After the acoustic level from the reinforcement path that is needed has been determined for a given lobe 304 to a given loudspeaker 320, the desired achievable gain needed to achieve this can be calculated using the locations and distances from step 502 and the characteristics from step 504. The contributing factors of the reinforcement path may include, for example, the acoustic attenuation from the talker to the microphone array 302, the sensitivity of the microphone array 302, the desired achievable gain applied by the controller 108, other processing device gains, the sensitivity of the loudspeaker 320, the amplifier level of the loudspeaker 320, and/or the acoustic path attenuation from the loudspeaker 320 to the position of the listener. In some embodiments, there may be other contributing factors if the calculated levels are found to differ from the ideal levels. The desired achievable gain may be the gain that, if applied based on the calculations outlined above, would have the level from the acoustic reinforcement path approximately equal to the level that was previously calculated as being needed. The desired achievable gains that are calculated at step 508 may correspond to ensuring that the volume of the sounds of the desired audio sources are played on the loudspeakers 320 to be at a sufficient sound pressure level such that listeners can intelligibly hear the sounds of the desired audio sources.

At step 510, the desired achievable gains of the lobes 304 may be refined by the controller 108 based on the acoustic characteristics of the environment (from step 504). For example, if a room is more reverberant, e.g., with hard wall surfaces, less reinforcement gain may be desired due to the higher reverberant sound from the talker. As another example, if a room has a higher noise floor, more reinforcement gain may be desired.

At step 512, the desired achievable gains of the lobes 304 may be further calculated by the controller 108 based on input from users to modify the default behavior. For example, the desired achievable gains may be decreased or increased based on a user-specified desired gain that could be set to have reinforcement levels lower or higher than the default. The desired achievable gains may also be modified based on user-specified zone definitions where the user could set the boundaries and/or microphone and loudspeaker groupings of a coverage zone 604 and/or a reinforcement zone 602 that would have different levels than the default.

In addition, in some scenarios the desired achievable gains may not be able to be used for paths between particular lobes 304 and particular loudspeakers 320. For example, there may be certain groupings of lobes 304 and/or certain groupings of loudspeakers 320 that need to use the same gain values. In these scenarios, there may not be a distinct cross point from each lobe 304 to each loudspeaker 320, and the controller 108 may calculate a desired achievable gain that may not be fully optimal but could be applied to a grouping of devices. For example, if the same audio signal is to be sent to a group of loudspeakers 320, a desired achievable gain value may be determined as a “compromise” value since each loudspeaker 320 may not have its own cross point output.

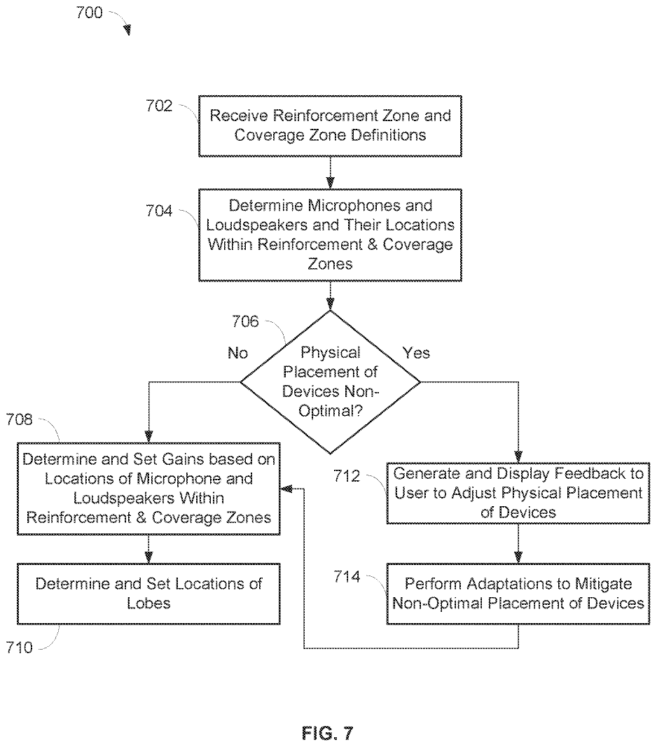

FIG. 7 shows an embodiment of a process 700 for automatically determining the gains of lobes 304 of the microphone arrays 302 based on the definitions of reinforcement and coverage zones in an environment, such as the environment 600 of FIG. 6. By using the process 700, the audio system 100 can be automatically and optimally configured with less involvement from an installer or integrator, e.g., by not needing to consider and configure each of the microphone arrays 302, lobes 304, and loudspeakers 320. In embodiments, the process 700 may be utilized in sound reinforcement scenarios.

At step 702 of the process 700, the definitions of the reinforcement zone 602 and the coverage zone 604 may be received at the controller 108. The definitions of the reinforcement zone 602 and the coverage zone 604 may include the boundaries for the zones within the environment 600, and may have been manually denoted or entered, such as through the user interface 110. As seen in the exemplary environment 600 of FIG. 6, the reinforcement zone 602 may include an area where the sound from talkers and other desirable audio sources may be reinforced to when played over certain loudspeakers 320. This area may include, for example, where some or all of the listeners are located. In embodiments, the reinforcement zone 602 may include the area where the listeners that are farthest away from a talker are expected to be located. The coverage zone 604 may include an area where the sound from talkers and other desirable audio sources may be sensed by the microphone arrays 302. This area may include, for example, where the desired audio sources are expected to be located, such as the presenter 306.

At step 704, the controller 108 may determine which of the microphone arrays 302, lobes 304, and loudspeakers 320 are within the reinforcement zone 602 and the coverage zone 604, based on the locations of the microphone arrays 302, lobes 304, and loudspeakers 320. The locations of the microphone arrays 302 and the loudspeakers 320 may have been manually entered through the user interface 110 and/or automatically determined. The controller 108 may determine which microphone arrays 302, lobes 304, and loudspeakers 320 are within the reinforcement zone 602 and the coverage zone 604 by comparing their locations to the boundaries of the reinforcement zone 602 and the coverage zone 604, in embodiments.

At step 706, the controller 108 may determine whether the physical placement of the microphone arrays 302 and loudspeakers 320 in the environment 600 may be expected to result in poor or non-optimal performance of the audio system 100. Poor or non-optimal performance of the audio system 100 may include an increased tendency to have feedback or ringing on the loudspeakers 320 at a given reinforcement level. The placement of the microphone arrays 302 and the loudspeakers 320 may also be non-optimal (relative to zones) when a reinforcement zone does not include loudspeakers 320 or a coverage zone does not include a microphone array 302 and/or a lobe 304 (e.g., making it difficult to detect sound in the coverage zone).

If the physical placement of the microphone arrays 302 and loudspeakers 320 is not considered non-optimal at step 706 (“NO” branch) (e.g., is considered optimal or will result in sufficient performance of the audio system 100), then the process 700 may continue to step 708. At step 708, the gains of one or more of the lobes 304 of the microphone arrays 302 may be determined and set by the controller 108. The gains of the lobes 304 may be determined and set based on the locations of the microphone arrays 302, where the lobes 304 are pointed, and the locations of the loudspeakers 320 that are in the reinforcement zone 602 and the coverage zone 604. In embodiments, the cross points between the lobes 304 and the loudspeakers 320 may also be determined and set at step 708.

In embodiments, the gains of the lobes 304 may be determined and set at step 708 using the process 400 shown in FIG. 4 as described above, e.g., based on determining potential gains and desired achievable gains for the cross points. For example, the locations of certain microphone arrays 302 and the loudspeakers 320 within the reinforcement zone 602 and the coverage zone 604 may be characteristics associated with the audio system 100 received at step 402 and utilized by other steps of the process 400, e.g., step 404 to calculate potential gains and step 406 to calculate desired achievable gains.

Examples of how the reinforcement zone 602 and the coverage zone 604 can affect the calculation of potential gains and desired achievable gains are now described. If reinforcement from a given coverage zone 604 is desired to be 10 dB higher, the desired achievable gain may be increased by 10 dB relative to the default for the cross points corresponding to the lobes 304 within the coverage zone 604. The increased desired achievable gain may be constrained or limited by the calculation of the potential gain for the cross points as applied at step 414, for example. This limitation may result in some or all of the lobes 304 in the coverage zone 604 to some or all of the loudspeakers 320 as not being able to get the 10 dB of desired added gain. However, if a coverage zone 604 has no coverage in a particular area, the desired achievable gain for the cross points of lobes 304 in that area may be highly attenuated rather than increased.

Similar methodologies may be utilized for a reinforcement zone 602. For example, the desired achievable gains for the cross points for a particular set of loudspeakers 320 within a reinforcement zone 602 may be raised or lowered, based on how the desired zone-based reinforcement characteristics differ from the default calculations. These modified values for the desired achievable gains may also be constrained based on potential gains, similar to what occurs at step 414, for example.

In embodiments, following step 708, the locations of the lobes 304 may be controlled by the controller 108 at step 710, based on the locations of the microphone arrays 302 and the loudspeakers 320 within the reinforcement zone 602 and the coverage zone 604, as well as based on the locations of desired audio sources within the coverage zone 604. For example, a talker located within the coverage zone 604 may be sensed by a microphone array 302 located in the coverage zone 604, and a lobe 304 of the microphone array 302 may be steered so that its location senses sound from the talker. The sound from the talker may then be played on one or more of the loudspeakers 320 located in the reinforcement zone 602. In some embodiments, when a position of a lobe 304 is changed at step 710, the gains of the lobes 304 may be re-determined and set based on the new position, e.g., at step 708.

Returning to step 706, if the physical placement of the microphone arrays 302 and loudspeakers 320 is considered non-optimal (“YES” branch), then the process 700 may continue to step 712. At step 712, feedback may be generated and displayed by the controller 108, e.g., on the user interface 110, to inform users (such as installers and integrators) of the non-optimal physical placement of the microphone arrays 302 and loudspeakers 320. The feedback generated and displayed at step 712 may include suggestions on how to adjust and optimize the physical placement of the microphone arrays 302 and loudspeakers 320 to achieve better performance of the audio system 100.

Following step 712, the controller 108 may perform one or more adaptations in response to the expected poor performance of the audio system 100 at step 714. The adaptations at step 714 may be performed to attempt to mitigate the ringing and/or feedback that is expected to result from a non-optimal physical placement of the microphone arrays 302 and loudspeakers 320. Following step 714, the process 700 may continue to steps 708 and 710 as described above to determine and set gains of the lobes 304 of the microphone arrays 302, and to control the locations of the lobes 304 to sense sounds of desired audio sources. The process 700 may perform steps 708 and 710 even if the physical placement of the microphone arrays 302 and loudspeakers 320 is considered non-optimal since it may still be beneficial to use a non-optimized audio system, e.g., so that listeners can better hear the sound of a desired audio source being played on a loudspeaker 320, as compared to if no adjustments were made to the gains of lobes 304. In embodiments, the controller 108 may also perform the one or more adaptations at step 714 when the physical placement of the devices is not considered non-optimal at step 706.

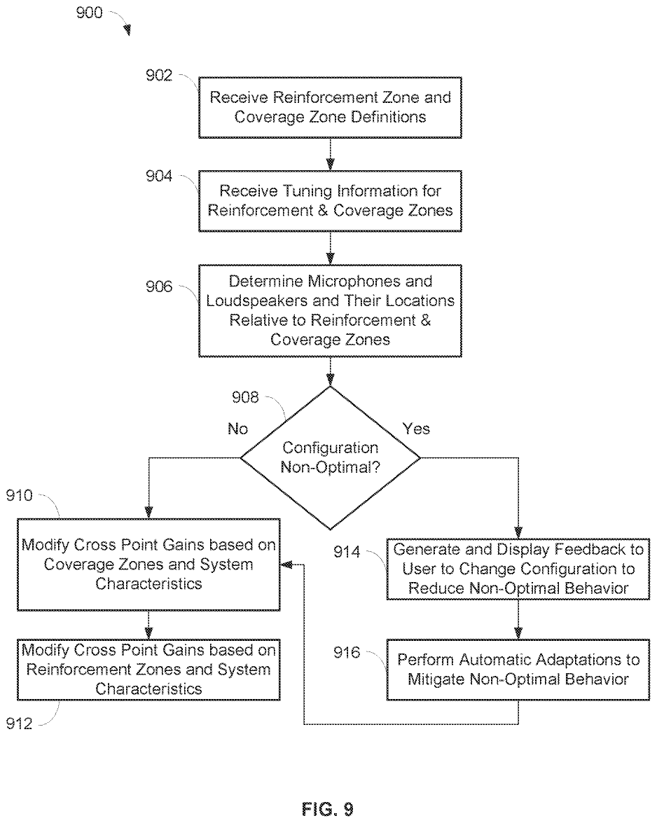

FIG. 9 shows an embodiment of a process 900 for automatically modifying the cross point gains of the matrix mixer 106 based on the definitions of reinforcement and coverage zones in an environment, such as the environment 600 of FIG. 6. By using the process 900, the audio system 100 can be automatically and optimally configured with less involvement from an installer or integrator, e.g., by not needing to consider and configure each of the microphone arrays 302, lobes 304, and loudspeakers 320. In embodiments, the process 900 may be utilized in any of the other techniques described herein, e.g., processes 400, 500, and/or 700.

At step 902 of the process 900, the definitions of the reinforcement zone 602 and the coverage zone 604 may be received at the controller 108. The definitions of the reinforcement zone 602 and the coverage zone 604 may include the boundaries for the zones within the environment 600, and may have been manually denoted or entered, such as through the user interface 110. As seen in the exemplary environment 600 of FIG. 6, the reinforcement zone 602 may include an area where the sound from talkers and other desirable audio sources may be reinforced to when played over certain loudspeakers 320. This area may include, for example, where some or all of the listeners are located. In embodiments, the reinforcement zone 602 may include the area where the listeners that are farthest away from a talker are expected to be located. The coverage zone 604 may include an area where the sound from talkers and other desirable audio sources may be sensed by the microphone arrays 302. This area may include, for example, where the desired audio sources are expected to be located, such as the presenter 306.

At step 904, tuning information associated with the reinforcement zone 602 and the coverage zone 604 may be received by the controller 108, such as from the user through the user interface 110. The tuning information may include a decrease or increase in the gain for particular coverage zones 604 and/or reinforcement zones 602. In embodiments, the tuning information received at step 904 may include a decrease or increase in the gain of groupings of particular coverage zones 604 and/or reinforcement zones 602.

At step 906, the controller 108 may determine which of the microphone arrays 302, lobes 304, and loudspeakers 320 are within the reinforcement zone 602 and the coverage zone 604, based on the locations of the microphone arrays 302, lobes 304, and loudspeakers 320. The locations of the microphone arrays 302 and the loudspeakers 320 may have been manually entered through the user interface 110 and/or automatically determined. The controller 108 may determine which microphone arrays 302, lobes 304, and loudspeakers 320 are within the reinforcement zone 602 and the coverage zone 604 by comparing their locations to the boundaries of the reinforcement zone 602 and the coverage zone 604, in embodiments.

At step 908, the controller 108 may determine whether the configuration of the audio system 100 may result in poor or non-optimal performance. For example, the controller 108 may determine that the audio system 100 may have poor or non-optimal performance based on the definitions of the reinforcement zone 602 and the coverage zone 604 (e.g., received at step 902), characteristics of the audio system 100, and/or characteristics of the reinforcement zone 602 and the coverage zone 604. Poor or non-optimal performance of the audio system 100 may include an increased tendency to have feedback or ringing on the loudspeakers 320 at a given reinforcement level, talkers in a coverage zone 604 not being heard effectively, or areas of the reinforcement zone 602 not having adequate reinforcement levels.

In embodiments, characteristics of the reinforcement zone 602 and the coverage zone 604 that may contribute to poor or non-optimal performance of the audio system 100 may include the placement of the microphone arrays 302 and the loudspeakers 320, relative to the reinforcement zone 602 and the coverage zone 604. This may include, for example, when the reinforcement zone 602 does not include loudspeakers 320 or the coverage zone 604 does not include a microphone array 302 and/or a lobe 304 (e.g., making it difficult to detect sound in the coverage zone).

If the configuration of the audio system 100 is not considered non-optimal at step 908 (“NO” branch) (e.g., is considered optimal or will result in sufficient performance of the audio system 100), then the process 900 may continue to step 910. At step 910, the cross point gains for particular lobes 304 within the coverage zone 604 may be modified, based on the definition of the coverage zone 604 and characteristics of the audio system 100. For example, if reinforcement from a given coverage zone 604 is desired to be 10 dB higher, the desired achievable gain may be increased by 10 dB relative to the default for the cross points corresponding to the lobes 304 within the coverage zone 604 at step 910. The increased desired achievable gain may be constrained or limited by the calculation of the potential gain for the cross points as applied at step 414, for example. This limitation may result in some or all of the lobes 304 in the coverage zone 604 to some or all of the loudspeakers 320 as not being able to get the 10 dB of desired added gain. However, if a coverage zone 604 has no coverage in a particular area, the desired achievable gain for the cross points of lobes 304 in that area may be highly attenuated rather than increased.

Following step 910, at step 912, the cross point gains for particular loudspeakers 320 within the reinforcement zone 602 may be modified, based on the definition of the reinforcement zone 602 and characteristics of the audio system 100. For example, the desired achievable gains for the cross points for a particular set of loudspeakers 320 within a reinforcement zone 602 may be raised or lowered at step 912, based on how the desired zone-based reinforcement characteristics differ from the default calculations. These modified values for the desired achievable gains may also be constrained based on potential gains, similar to what occurs at step 414, for example.

Returning to step 908, if the configuration of the audio system 100 is considered non-optimal (“YES” branch), then the process 900 may continue to step 914. At step 914, feedback may be generated and displayed by the controller 108, e.g., on the user interface 110, to inform and advise users (such as installers and integrators) about the potential non-optimal behavior of the audio system 100 (as related to the coverage zone 604 and/or the reinforcement zone 602), and suggestions to change the configuration of the audio system 100 to reduce the potential non-optimal behavior. The feedback generated and displayed at step 914 may include, for example, instructions to add or move a microphone array 302 and/or a lobe 304 if it is determined the existing microphone arrays 302 and/or lobes 304 in a coverage zone 604 would result in insufficient coverage. As another example, the feedback at step 914 may include instructions to add or move a loudspeaker 320 if it is determined that the existing loudspeakers 320 in a reinforcement zone 602 would result in insufficient coverage. As further example, the feedback at step 914 may include suggestions to adjust the boundaries of the coverage zone 604 and/or reinforcement zone 602 to work better with the existing placement of the microphone arrays 302, lobes 304, and/or loudspeakers 320.

Following step 914, at step 916, the controller 108 may automatically perform one or more adaptations to the configuration of the audio system 100 to mitigate its potential non-optimal behavior, e.g., ringing and/or feedback that is expected to result from the current configuration of the audio system 100. For example, if there is a gap in the coverage of a reinforcement zone 602, the controller 108 may add a loudspeaker 320 located just outside the reinforcement zone 602 to help fill in the gap and/or the controller 108 may increase the cross point gain of a loudspeaker 320 in the reinforcement zone 602 to widen and improve its area of coverage. As another example, the controller 108 may modify the configuration of lobes 304 or their cross point gains to improve their coverage in a coverage zone 604. As a further example, the controller 108 may modify the boundaries of a coverage zone 604 or a reinforcement zone 602 in order to improve the behavior of the audio system 100. Following step 916, the process 900 may continue to steps 910 and 912 as described above to modify the cross point gains of lobes 304 and/or loudspeakers 320.

The description herein describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.
Clause 1. A method comprising: receiving one or more characteristics associated with an audio system located in an environment, wherein the audio system comprises a plurality of microphone arrays each having one or more lobes, a plurality of loudspeakers, and a matrix mixer comprising one or more cross points each configured to connect each of the one or more lobes of the plurality of microphone arrays with each of the plurality of loudspeakers.
Clause 2. The method of clause 1, further comprising: calculating a potential gain for each of the one or more cross points, based on the one or more characteristics.
Clause 3. The method of any of the foregoing clauses, further comprising: calculating a desired achievable gain for each of the one or more cross points, based on the one or more characteristics and a desired reinforcement level.
Clause 4. The method of any of the foregoing clauses, further comprising: in an instance in which the potential gain is greater than or equal to the desired achievable gain for the one or more cross points, applying the desired achievable gain as a gain of the one or more cross points.
Clause 5. The method of any of the foregoing clauses, wherein the potential gain comprises one or more of: a potential acoustic gain of the one or more lobes of each of the plurality of microphone arrays, a sensitivity of each of the plurality of microphone arrays, or a sensitivity of each of the plurality of loudspeakers.
Clause 6. The method of any of the foregoing clauses, wherein the one or more characteristics associated with the audio system comprise one or more of: locations of the plurality of microphone arrays, locations of the one or more lobes of the plurality of microphone arrays, locations of the plurality of loudspeakers, a location of a desired audio source, a location of a listener, a level of acoustic coupling between the plurality of microphone arrays and the plurality of loudspeakers, a user-specified desired gain, or a user-specified zone definition.
Clause 7. The method of any of the foregoing clauses, wherein in an instance in which the potential gain is less than the desired achievable gain, the method further comprises: determining a constrained gain of the one or more cross points such that the desired achievable gain is within the potential gain; and applying the constrained gain as the gain of the one or more cross points.
Clause 8. The method of any of the foregoing clauses, further comprising optimizing one or more cross point potential gains associated with an input channel or an output channel of the audio system.
Clause 9. The method of any of the foregoing clauses, wherein optimizing the one or more cross point potential gains comprises applying a shelf filter for the plurality of microphone arrays based on frequencies of an audio signal of a desired audio source and the desired reinforcement level.
Clause 10. The method of any of the foregoing clauses, wherein optimizing the potential gain comprises applying a notch filter based on the one or more characteristics.
Clause 11. The method of any of the foregoing clauses, wherein calculating the potential gain comprises refining the calculated potential gain for at least one of the one or more cross points.
Clause 12. The method of any of the foregoing clauses, wherein calculating the desired achievable gain comprises refining the calculated desired achievable gain for at least one of the one or more cross points.
Clause 13. The method of any of the foregoing clauses, wherein calculating the desired achievable gain comprises: receiving a distance between a location of a desired audio source and the plurality of microphone arrays; receiving acoustic characteristics associated with one or more of the plurality of microphone arrays, the plurality of loudspeakers, and the environment; determining a volume of the desired audio source based on: (1) the distance between the location of the desired audio source and the plurality of microphone arrays, and (2) the acoustic characteristics of the plurality of microphone arrays; and calculating the desired achievable gain by determining the desired reinforcement level based on: (1) the determined volume of the desired audio source, and (2) the acoustic characteristics of the plurality of loudspeakers.
Clause 14. The method of any of the foregoing clauses, wherein calculating the desired achievable gain further comprises calculating the desired achievable gain of the one or more cross points based on the acoustic characteristics of the environment.
Clause 15. The method of any of the foregoing clauses, wherein calculating the desired achievable gain further comprises calculating the desired achievable gain of the one or more cross points based on a distance between the location of the desired audio source to a subset of the plurality of microphone arrays.
Clause 16. The method of any of the foregoing clauses, wherein the subset of the plurality of microphone arrays comprises one or more of the plurality of microphone arrays that are located within a reinforcement zone of the environment associated with the audio system.
Clause 17. The method of any of the foregoing clauses, further comprising: monitoring for changes to the one or more characteristics associated with the audio system; and in an instance in which one or more of the one or more characteristics associated with the audio system has changed, performing steps of calculating the potential gain, calculating the desired achievable gain, and adjusting the gain, based on the changed one or more characteristics.
Clause 18. The method of any of the foregoing clauses, further comprising adjusting the gain for the one or more cross points related to the one or more lobes of the plurality of microphone arrays or the plurality of loudspeakers that are associated with the changed one or more characteristics.
Clause 19. The method of any of the foregoing clauses, wherein the audio system further comprises an automixing system in communication with the plurality of microphone arrays, the plurality of loudspeakers, and the matrix mixer; and wherein the automixing system is configured to generate one or more submix audio signals from audio signals associated with the one or more lobes of the plurality of microphone arrays, and a gating control signal; and wherein the one or more cross points of the matrix mixer are further configured to connect each of the one or more submix audio signals with each of the plurality of loudspeakers.
Clause 20. The method of any of the foregoing clauses, wherein calculating the potential gain comprises calculating the potential gain for each of the one or more cross points, based on the one or more characteristics and the gating control signal; and wherein calculating the desired achievable gain comprises calculating the desired achievable gain for each of the one or more cross points based on the one or more characteristics, the desired reinforcement level, and the gating control signal.
Clause 21. The method of any of the foregoing clauses, further comprising: determining whether a performance of the audio system is expected to be non-optimal, based on locations of the plurality of microphone arrays and the plurality of loudspeakers.
Clause 22. The method of any of the foregoing clauses, further comprising: in an instance in which the performance of the audio system is expected to be non-optimal: generating and displaying a message related to adjusting one or more of the locations of the plurality of microphone arrays and the plurality of loudspeakers; and updating the one or more characteristics associated with the audio system in response to adjusting the one or more of the locations of the plurality of microphone arrays and the plurality of loudspeakers.
Clause 23. The method of any of the foregoing clauses, wherein determining whether the performance of the audio system is expected to be non-optimal comprises determining whether one or more of feedback or ringing is expected to be present in the audio system, based on the locations of the plurality of microphone arrays and the plurality of loudspeakers.
Clause 24. The method of any of the foregoing clauses, wherein determining whether one or more of feedback or ringing is expected to be present in the audio system is further based on one or more of: locations of the one or more lobes of the plurality of microphone arrays, a location of a desired audio source, a location of a listener, or a level of acoustic coupling between the plurality of microphone arrays and the plurality of loudspeakers.
Clause 25. The method of any of the foregoing clauses, further comprising adjusting one or more parameters of the audio system to reduce one or more of feedback or ringing in an input channel or an output channel of the audio system.
Clause 26. The method of any of the foregoing clauses, wherein adjusting the one or more parameters of the audio system comprises one or more of: executing a digital feedback reduction function, using a limiter, or executing a number of open microphones attenuator function.
Clause 27. A method comprising: receiving a definition of a coverage zone and a definition of a reinforcement zone associated with an audio system located in an environment, wherein the audio system comprises a plurality of microphone arrays each having one or more lobes, a plurality of loudspeakers, and a matrix mixer comprising one or more cross points each configured to connect each of the one or more lobes of the plurality of microphone arrays with each of the plurality of loudspeakers, wherein the coverage zone denotes a first area of the environment where audio of a desired audio source is captured by one or more of the plurality of microphone arrays, and wherein the reinforcement zone denotes a second area of the environment where the audio of the desired audio source is amplified for playing on one or more of the plurality of loudspeakers.
Clause 28. The method of any of the foregoing clauses, further comprising: determining a first subset of the plurality of microphone arrays and a first subset of the plurality of loudspeakers located in the coverage zone, and a second subset of the plurality of microphone arrays and a second subset of the plurality of loudspeakers located in the reinforcement zone.
Clause 29. The method of any of the foregoing clauses, further comprising: determining and setting a gain of the one or more cross points, based on: locations of the first subset of the plurality of microphone arrays in the coverage zone, locations of the first subset of the plurality of loudspeakers in the coverage zone, locations of the second subset of the plurality of microphone arrays in the reinforcement zone, and locations of the second subset of the plurality of loudspeakers in the reinforcement zone.
Clause 30. The method of any of the foregoing clauses, wherein determining and setting a location of the one or more lobes of the plurality of microphone arrays, is further based on locations of desired audio sources in the coverage zone.
Clause 31. The method of any of the foregoing clauses, wherein determining and setting the gain of the one or more cross points comprises: calculating a desired achievable gain for each of the one or more cross points based on an audio system characteristic associated with the audio system and a desired reinforcement level; and adjusting the gain of the one or more cross points to the desired achievable gain.
Clause 32. The method of any of the foregoing clauses, wherein the audio system characteristic comprises one or more of: the locations of the plurality of microphone arrays, locations of the one or more lobes of the plurality of microphone arrays, the locations of the plurality of loudspeakers, a location of the desired audio source, a level of acoustic coupling between the plurality of microphone arrays and the plurality of loudspeakers, or a user-specified desired gain.
Clause 33. The method of any of the foregoing clauses, wherein calculating the desired achievable gain comprises: receiving a distance between a location of the desired audio source and the plurality of microphone arrays; receiving acoustic characteristics associated with the plurality of microphone arrays, the plurality of loudspeakers, and the environment; determining a volume of the desired audio source based on: (1) the distance between the location of the desired audio source and the plurality of microphone arrays and (2) the acoustic characteristics of the plurality of microphone arrays; and calculating the desired achievable gain by determining the desired reinforcement level based on: (1) the determined volume of the desired audio source and (2) the acoustic characteristics of the plurality of loudspeakers.

1. A method, comprising:
receiving one or more characteristics associated with an audio system located in an environment, wherein the audio system comprises a plurality of microphone arrays each having one or more lobes, a plurality of loudspeakers, and a matrix mixer comprising one or more cross points each configured to connect each of the one or more lobes of the plurality of microphone arrays with each of the plurality of loudspeakers;
calculating a potential gain for each of the one or more cross points, based on the one or more characteristics;
calculating a desired achievable gain for each of the one or more cross points, based on the one or more characteristics and a desired reinforcement level; and
in an instance in which the potential gain is greater than or equal to the desired achievable gain for the one or more cross points, applying the desired achievable gain as a gain of the one or more cross points.

2. (canceled)

3. (canceled)

4. The method of claim 1, wherein in an instance in which the potential gain is less than the desired achievable gain, the method further comprises:
determining a constrained gain of the one or more cross points such that the desired achievable gain is within the potential gain; and applying the constrained gain as the gain of the one or more cross points.

5. The method of claim 1, further comprising optimizing one or more cross point potential gains associated with an input channel or an output channel of the audio system.

6. The method of claim 5, wherein optimizing the one or more cross point potential gains comprises applying a shelf filter for the plurality of microphone arrays based on frequencies of an audio signal of a desired audio source and the desired reinforcement level.

7. (canceled)

8. (canceled)

9. (canceled)

10. The method of claim 1, wherein calculating the desired achievable gain comprises:
receiving a distance between a location of a desired audio source and the plurality of microphone arrays;
receiving acoustic characteristics associated with one or more of the plurality of microphone arrays, the plurality of loudspeakers, and the environment;
determining a volume of the desired audio source based on: (1) the distance between the location of the desired audio source and the plurality of microphone arrays, and (2) the acoustic characteristics of the plurality of microphone arrays; and
calculating the desired achievable gain by determining the desired reinforcement level based on: (1) the determined volume of the desired audio source, and (2) the acoustic characteristics of the plurality of loudspeakers.

11. The method of claim 10, wherein calculating the desired achievable gain further comprises calculating the desired achievable gain of the one or more cross points based on the acoustic characteristics of the environment.

12. The method of claim 10, wherein calculating the desired achievable gain further comprises calculating the desired achievable gain of the one or more cross points based on a distance between the location of the desired audio source to a subset of the plurality of microphone arrays.

13. The method of claim 12, wherein the subset of the plurality of microphone arrays comprises one or more of the plurality of microphone arrays that are located within a reinforcement zone of the environment associated with the audio system.

14. The method of claim 1, further comprising:
monitoring for changes to the one or more characteristics associated with the audio system; and
in an instance in which one or more of the one or more characteristics associated with the audio system has changed, performing steps of calculating the potential gain, calculating the desired achievable gain, and adjusting the gain, based on the changed one or more characteristics.

15. The method of claim 14, further comprising adjusting the gain for the one or more cross points related to the one or more lobes of the plurality of microphone arrays or the plurality of loudspeakers that are associated with the changed one or more characteristics.

16. The method of claim 1, wherein the audio system further comprises an automixing system in communication with the plurality of microphone arrays, the plurality of loudspeakers, and the matrix mixer; and wherein the automixing system is configured to generate one or more submix audio signals from audio signals associated with the one or more lobes of the plurality of microphone arrays, and a gating control signal; and wherein the one or more cross points of the matrix mixer are further configured to connect each of the one or more submix audio signals with each of the plurality of loudspeakers.

17. The method of claim 16, wherein calculating the potential gain comprises calculating the potential gain for each of the one or more cross points, based on the one or more characteristics and the gating control signal; and wherein calculating the desired achievable gain comprises calculating the desired achievable gain for each of the one or more cross points based on the one or more characteristics, the desired reinforcement level, and the gating control signal.

18. The method of claim 1, further comprising:
determining whether a performance of the audio system is expected to be non-optimal, based on locations of the plurality of microphone arrays and the plurality of loudspeakers; and
in an instance in which the performance of the audio system is expected to be non-optimal:
generating and displaying a message related to adjusting one or more of the locations of the plurality of microphone arrays and the plurality of loudspeakers; and
updating the one or more characteristics associated with the audio system in response to adjusting the one or more of the locations of the plurality of microphone arrays and the plurality of loudspeakers.

19. (canceled)

20. The method of claim 18, wherein determining whether the performance of the audio system is expected to be non-optimal comprises determining whether one or more of feedback or ringing is expected to be present in the audio system, based on the locations of the plurality of microphone arrays and the plurality of loudspeakers.

21. The method of claim 20, wherein determining whether one or more of feedback or ringing is expected to be present in the audio system is further based on one or more of: locations of the one or more lobes of the plurality of microphone arrays, a location of a desired audio source, a location of a listener, or a level of acoustic coupling between the plurality of microphone arrays and the plurality of loudspeakers.

22. (canceled)

23. (canceled)

24. A method, comprising:
receiving a definition of a coverage zone and a definition of a reinforcement zone associated with an audio system located in an environment, wherein the audio system comprises a plurality of microphone arrays each having one or more lobes, a plurality of loudspeakers, and a matrix mixer comprising one or more cross points each configured to connect each of the one or more lobes of the plurality of microphone arrays with each of the plurality of loudspeakers, wherein the coverage zone denotes a first area of the environment where audio of a desired audio source is captured by one or more of the plurality of microphone arrays, and wherein the reinforcement zone denotes a second area of the environment where the audio of the desired audio source is amplified for playing on one or more of the plurality of loudspeakers;
determining a first subset of the plurality of microphone arrays and a first subset of the plurality of loudspeakers located in the coverage zone, and a second subset of the plurality of microphone arrays and a second subset of the plurality of loudspeakers located in the reinforcement zone; and
determining and setting a gain of the one or more cross points, based on: locations of the first subset of the plurality of microphone arrays in the coverage zone, locations of the first subset of the plurality of loudspeakers in the coverage zone, locations of the second subset of the plurality of microphone arrays in the reinforcement zone, and locations of the second subset of the plurality of loudspeakers in the reinforcement zone.

25. The method of claim 24, wherein determining and setting a location of the one or more lobes of the plurality of microphone arrays, is further based on locations of desired audio sources in the coverage zone.

26. The method of claim 24, wherein determining and setting the gain of the one or more cross points comprises:
calculating a desired achievable gain for each of the one or more cross points based on an audio system characteristic associated with the audio system and a desired reinforcement level; and
adjusting the gain of the one or more cross points to the desired achievable gain.

27. The method of claim 26, wherein the audio system characteristic comprises one or more of: the locations of the plurality of microphone arrays, locations of the one or more lobes of the plurality of microphone arrays, the locations of the plurality of loudspeakers, a location of the desired audio source, a level of acoustic coupling between the plurality of microphone arrays and the plurality of loudspeakers, or a user-specified desired gain.

28. The method of claim 26, wherein calculating the desired achievable gain comprises:
receiving a distance between a location of the desired audio source and the plurality of microphone arrays;
receiving acoustic characteristics associated with the plurality of microphone arrays, the plurality of loudspeakers, and the environment;
determining a volume of the desired audio source based on: (1) the distance between the location of the desired audio source and the plurality of microphone arrays and (2) the acoustic characteristics of the plurality of microphone arrays; and
calculating the desired achievable gain by determining the desired reinforcement level based on: (1) the determined volume of the desired audio source and (2) the acoustic characteristics of the plurality of loudspeakers.
